(19) United States
(12) Patent Application Publication
(10) Pub. No.: US 2026/0234513 A1
(43) Pub. Date: Aug. 13, 2026

(54) UNIT DOSE COMPOSITIONS, METHODS OF MAKING THE UNIT DOSE COMPOSITIONS AS A UNIFIED SOLID

(71) Applicant: Church & Dwight Co., Inc., Princeton, NJ (US)

(72) Inventor: Steven T. ADAMY, Lawrenceville, NJ (US)

(73) Assignee: Church & Dwight Co., Inc., Princeton, NJ (US)

(21) Appl. No.: 19/134,025

(22) PCT Filed: Nov. 30, 2023
(86) PCT No.: PCT/US2023/081807

§ 371 Date: May 29, 2025

Related U.S. Application Data
(60) Provisional application No. 63/429,198, filed on Dec. 1, 2022.

(51) Int. Cl. C11D 17/04; C11D 3/04; C11D 3/20; C11D 3/34; C11D 3/37

(52) U.S. Cl. CPC C11D 17/044; C11D 3/046; C11D 3/2017; C11D 3/2068; C11D 3/34; C11D 3/3776

(57) ABSTRACT

Presently provided are unit dose compositions. The unit dose compositions enable delivery of detergent materials in a unit dose format that does not require a surrounding film yet retains product integrity during storage and transportation due to exhibiting necessary hardness and deformation properties. The disclosure also provides methods for preparing unit dose compositions that are configured as a unified solid.

### FIELD OF THE INVENTION

The present disclosure relates to unit dose compositions useful for providing various materials, such as detergents, in a unit dose form. More particularly, the unit dose compositions effectively provide the various materials in a format that does not include or require partial nor full enclosure in a film or envelope made of material, such as poly(vinyl alcohol) [PVOH]. The disclosure likewise relates to methods for making the unit dose compositions.

### BACKGROUND

There is an increasing emphasis on consumer products that are both convenient for the consumer and less detrimental to the environment e.g., through minimization of a carbon footprint via reduced packaging. One example is the emergence of “unit-dose” or “single-dose” systems for laundry applications, dishwashing, and similar uses where essential ingredients are in a compact pod or other unit that can be added to washing machines, dishwashers, or the like. Upon contact with water, the pod, or unit, is intended to completely dissolve for release of the detergent components. Because such unit dose systems require less material for packaging and are easier to transport (for example, due to a lowered water content or complete removal of water), a lower energy input is required for product distribution.

Unit dose systems are often packaged with the dosage composition contained within an envelope, an enclosing film, or the like, to define the liquid or solid payload as an individual unit dose (i.e., a “pod”). These unit dose systems have largely used poly(vinyl alcohol) [PVOH] as a base packaging material, due its solubility in water. Particularly, partially hydrolyzed PVOH—with a degree of hydrolysis less than 89%, is used as the primary packaging material of choice, due its higher aqueous solubility compared with forms with greater degrees of hydrolysis. PVOH, however, can undergo hydrolysis when in contact with alkaline formulation components, which are routinely present in many cleaning products, in particular. As a result, the PVOH component, like a pod film, will then undergo hydrolysis, transforming to a packaging material with poor water solubility. Poor water solubility may cause the payload to not to be released in the wash or may leave remnants of packaging material as residue on the articles being washed (e.g., clothing, dishware, etc.). Accordingly, there remains a need for providing various compositions in a convenient unit dose form that is stable during transportation and storage, which does not require partial or full enclosure in a film or envelope, and that exhibits high efficacy while maintaining a unified solid format.

### SUMMARY OF THE DISCLOSURE

The present disclosure provides unit dose compositions. More particularly, the unit dose compositions can be configured as a unified solid that will dissolve in water. The composition is a self-contained unit dose in that it will retain its shape and mass (i.e., in the absence of being acted upon by excessive outside forces) without necessarily requiring an envelope, or a film, or other form of enclosing layer or component. A method of making the unit dose composition that is a unified solid and is not enclosed in a film or envelope is also presently disclosed.

In some embodiments, a unit dose composition, according to the present disclosure can comprise: a complex of an alcohol and an anhydrous salt; a structuring agent; and a detergent, wherein the unit dose composition is configured as a unified solid. In one or more further embodiments, the unit dose composition can be defined in relation to one or more of the following statements, which statements can be combined in any number or order without departing from the express language of the present disclosure.

The alcohol can be present in an amount of about 30% to about 45% based on the total weight of the unit dose composition.

The anhydrous salt can be an anhydrous chloride salt.

The anhydrous salt can include a cation with a Pauling electronegativity of at least 1.0.

The anhydrous salt can be present in an amount of about 30% to about 45% by weight based on the total weight of the unit dose composition.

The structuring agent can include a polymer.

The structuring agent can include an acetate polymer.

The structuring agent can include a copolymer of an acetate monomer with one or more further monomers.

The structuring agent can be present in an amount of about 5% to about 20% by weight based on the total weight of the unit dose composition.

The unit dose composition further can comprise a plasticizer.

The plasticizer can be a liquid that is effective to partially solubilize the structuring agent and increase binding of the structuring agent with the complex of the alcohol and the anhydrous salt.

The plasticizer can include a glycol hexyl ether.

The plasticizer can be present in an amount of about 0.1% to about 5% by weight based on the total weight of the unit dose composition.

The detergent can be selected from the group consisting of surfactants, builders, alkalinizing agents, enzymes, optical brighteners, antiredeposition polymers, fluorescent whitening agents, bleaches, pearl luster agents, and combinations thereof.

The unit dose composition, as a unified solid, can have a hardness value defined by exhibiting a peak force at breakage of at least 190 Newtons and a percent deformation at peak force of about 20% to about 30% when measured with a Brookfield Texture Analyzer.

The unit dose composition, as a unified solid, can be neither partially nor fully enclosed in a film or envelope.

The unit dose composition, as a unified solid, can be water soluble.

The unit dose composition, as a unified solid, can be configured to achieve at least 95% dissolution in deionized water in a time of about 30 seconds to about 8 minutes.

In some embodiments, a method of making a unit dose composition, according to present disclosure can comprise: combining a structuring agent, a detergent, and an alcohol to form a mixture; combining an anhydrous salt with the mixture to form an intermediate composition; and curing the intermediate composition in unit dose amounts under conditions such that the anhydrous salt reacts with the alcohol to form a complex that structurally includes the structuring agent and the detergent to provide the unit dose amounts as individual units of a unified solid.

The combining further can include combining a plasticizer to form the mixture.

### BRIEF DESCRIPTION OF THE FIGURES

FIG. 1 is a graphical representation of peak force (hardness) values plotted against the ratio of structuring agent to anhydrous salt for unit dose compositions prepared as a unified solid according to embodiments of the present disclosure.

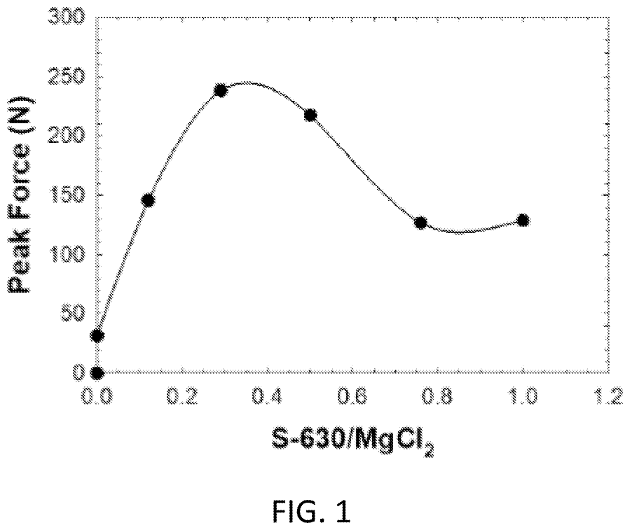

FIG. 2 is a graphical representation of values for the percent deformation at peak force (hardness) plotted against the ratio of structuring agent to anhydrous salt for unit dose compositions prepared as a unified solid according to embodiments of the present disclosure.

FIG. 3 is a graphical representation of Peak force (hardness) values plotted against the weight % of plasticizer used in unit dose compositions prepared as a unified solid according to embodiments of the present disclosure.

FIG. 4 is a graphical representation of values for the percent deformation at peak force (hardness) plotted against the weight % of plasticizer used in unit dose compositions prepared as a unified solid according to embodiments of the disclosure.

### DETAILED DESCRIPTION OF THE DISCLOSURE

The present disclosure now will be described more fully hereinafter. The disclosure can be embodied in many different forms and should not be construed as limited to the embodiments set forth herein; rather, these embodiments are provided so that this disclosure will satisfy applicable legal requirements. Like numbers refer to like elements throughout. As used in this specification and the claims, the singular forms “a,” “an,” and “the” include plural references unless the context clearly dictates otherwise.

In one or more embodiments, the present disclosure relates to a unit dose composition that is configured as a unified solid. The configuration as a unified solid can indicate that the unit dose is a monolithic structure. Preferably, the unit dose is unified such that a film or envelope is not required to contain the composition in a unit dose amount. In various embodiments, the unit dose compositions of the present disclosure can comprise a matrix that is a complex of an alcohol and an anhydrous salt and that carries and/or incorporates at least a structuring agent and a detergent, the matrix defining a unified, solid structure. A method of making the unit dose composition as a unified solid is also disclosed. Beneficially, the arrangement as a unified solid enables delivery of the detergent components to a site where detergency is desired (e.g., in a laundry washing machine, a dish washing machine, or the like) in a pre-dosed amount without the need for an enclosing film, envelope, or the like. Rather, the various components are held together by the matrix structure of the alcohol/anhydrous salt complex so that, under normal handling conditions, the unit dose compositions will substantially retain their original shape and mass as produced. Normal handling conditions are understood to mean that the unit dose compositions are maintained substantially dry (excepting ambient humidity conditions) and are not subject to excessive forces during transportation, storage, and handling. In other words, the unit dose compositions will exhibit structural integrity that would not be expected in a liquid composition or a powder composition that would require some manner of enclosure to retain the unit dose format.

In one or more embodiments, the unit dose compositions of the present disclosure can include a complex of an alcohol and an anhydrous salt. Without wishing to be bound by theory, it is believed that an alcohol and an anhydrous salt will combine in an exothermic reaction to form an alcoholate that structurally presents as a complex and/or, more specifically in certain embodiments, a crystal lattice. Thus, in one or more embodiments, the unit dose compositions of the present disclosure can be characterized as being a complex, a matrix, an alcoholate, or a salt alcoholate wherein the reaction product of an alcohol with an anhydrous salt defines a structure that additional components of the unit dose composition are carried by or incorporated therein.

A variety of alcohols can be used in the presently described unit dose compositions. The alcohol can be any material having an alcohol functionality. In addition, the alcohol will be a liquid at the alcoholate matrix formulation temperature such that the unit dose composition, which can include one or more of a polymer, a plasticizer, a nonionic surfactant, and a fragrance, can be dissolved or easily dispersed. The alcohol preferably is structured to effectively react with the anhydrous salt component to form a matrix structure as noted above. In some embodiments, the alcohol can be a primary alcohol, a secondary alcohol, and/or a tertiary alcohol. A single alcohol can be used, or a mixture of alcohols can be utilized. Isopropyl alcohol (i.e., propan-2-ol or 2-propanol) is a non-limiting example of a suitable alcohol for forming a matrix as described herein. For example, when formulating a matrix at 25 degrees Celsius (° C.), an alcohol ranging from methanol (C1) to 1-decanol (C10), or isomers thereof, can be used. In certain embodiments, any isomers of alcohols having greater numbers of carbons, such that the alcohols are liquid at the formulation temperature, can be used. In certain embodiments, the alcohol can be present in the final unit dose composition in an amount of about 25% to about 55% by weight, about 30% to about 45% by weight, about 32% to about 45% by weight, or about 35% to about 40% by weight, based on the total weight of the unit dose composition. In further embodiments, the unit dose composition can comprise at least 20%, at least 25%, at least 30%, or at least 35% by weight of the alcohol, based on the total weight of the unit dose composition. In such embodiments, an upper limit (i.e., no greater than) can be applied, such as an upper limit of 60%, 55%, 50%, or 45% by weight based on the total weight of the unit dose composition.

The anhydrous salt utilized in the present compositions can be any salt that is effective to react with an alcohol to form an alcoholate matrix. Metal salts can be preferred, but other salts effective to react with an alcohol to form an alcoholate matrix can be used. In some embodiments, the anhydrous salt can be a Group VII salt, such as a chloride salt, a fluoride salt, or a bromide salt. In further embodiments, the anhydrous salt can be characterized in relation to its cationic component. In particular, cations having a higher binding affinity for alcohols can lead to stronger intermolecular interactions between the anhydrous salt and the alcohol component of the matrix. The cation of the anhydrous salt can be selected from Group I and Group II metals, and preference can be given to those cations with higher electronegativities. In some embodiments, the anhydrous salt can specifically include a cation with an electronegativity of at least 0.98, at least 1.0, or at least 1.2. As such, calcium salts and magnesium salts particularly can be preferred. In particular, anhydrous chloride salts, such as anhydrous calcium chloride and/or anhydrous magnesium chloride can be particularly useful.

In various embodiments, the anhydrous salt can be present in the final unit dose composition in an amount of about 15% to about 55% by weight, about 25% to about 50% by weight, about 30% to about 45% by weight, or about 35% to about 45% by weight, based on the total weight of the unit dose composition. In further embodiments, the unit dose composition can comprise at least 15%, at least 20%, at least 25%, at least 30%, or at least 35% by weight of the anhydrous salt, based on the total weight of the unit dose composition. In such embodiments, an upper limit (i.e., no greater than) can be applied, such as an upper limit of 65%, 60%, 55%, or 50%, by weight based on the total weight of the unit dose composition.

In some embodiments, the composition can be defined in relation to ratio of alcohol to salt used in forming the composition. In particular, the ratio may be adjusted to define a specific dissolution time of the final, unit dose composition in water. The ratio of alcohol to salt can be, for example, about 0.5 to about 5, about 0.8 to about 4, about 0.9 to about 3, or about 1 to about 2, based on a w/w ratio of alcohol concentration to salt concentration. Using ratios at the higher end of the preferred ranges can be useful to provide faster dissolution times in water, and using ratios at the lower end of the preferred ranges can be useful to provide slower dissolution times in water.

The unit dose composition of the present disclosure can exhibit improved properties through inclusion of one or more components effective to increase structural integrity of the unit dose composition. Preferred additives can be effective for improving binding within the matrix between the structure resulting from the formation of the alcoholate. In one or more embodiments, the unit dose composition thus can include one or more structuring agents. In one or more embodiments, the structuring agent can be a polymer. The polymer or other structuring agent can be beneficial to provide increased structural integrity to the unit dose composition by improving binding within the complex. The structuring agent particularly can be useful to provide the desired hardness while also limiting brittleness. More particularly, the inclusion of the polymer structuring agent within the alcoholate complex can maintain overall hardness while imparting elasticity and/or plasticity that imparts toughness to the unit dose structure. For example, a vinyl acetate polymer or a copolymer of vinyl acetate monomer and at least a second monomer can be used. Similarly, vinylpyrrolidone polymer or a copolymer of vinylpyrrolidone monomer and at least a second monomer can be used. In specific embodiments, a polyvinylpyrrolidone-co-vinyl acetate (PVAc-PVP) can be used. In some embodiments, a povidone polymer can be used, such as the povidone sold under the tradename Plasdone™. While such polymers can be useful, it is understood that the polymer typically can be any polymer that is soluble in the alcohol that is used in forming a complex with the anhydrous salt. Solubility of the polymer in the alcohol can be assessed using the solubility parameter theory, also called the Hansen solubility parameters, which is a well-known criteria for assessing the compatibility of polymers with solvents, where the solubility parameter & is the square root of the cohesive energy density between solvent and solute (polymer) molecules. This is described, in particular, by Butreddy et al. [A. Butreddy, S. Sarabu, S. Bandari, A. Batra, K. Lawal, N. Ningyi Chen, V. Bi, T. During, and M. A. Repka, Influence of Plasdone S630 Ultra—an Improved Copovidone on the Processability and Oxidative Degradation of Quetiapine Fumarate Amorphous Solid Dispersions Prepared via Hot-Melt Extrusion Technique, PharmSci Tech 22, 196 (2021)]. Solubility parameters for various materials can be found in the literature, and solubility parameters for polymers, in particular, can be found in various on-line databases. The solubility parameter otherwise can be calculated as a measure of the intermolecular interactions associated with dispersion forces (δ_{d}), polarity forces (δₚ), and forces associated with hydrogen bonds (δₕ). The solubility parameter can be determined via a number of experimental methods cited in the scientific literature. For example, the solubility parameter can be calculated using Van Krevelen and Hoftyzer group contribution method by using the equations shown below.

$${δ}_{l} = \sqrt{{δ}_{d}^{2} + {δ}_{p}^{2} + {δ}_{h}^{2}}$$

$${δ}_{d} = \frac{\sum {F}_{di}}{V}$$

$${δ}_{p} = \sqrt{\frac{\sum {F}_{pi}^{2}}{V}}$$

$${δ}_{h} = \sqrt{\frac{\sum {E}_{hi}}{V}}$$

In the above equations, is the total solubility parameter; δ_{d}, δₚ, and δₕ are the parameters associated with dispersive forces, polar forces, and hydrogen bonding, respectively; and F_{di}, Fₚᵢ, and Eₕᵢ are the molar attraction constants due to dispersion, polar component, and hydrogen bonding energy, respectively. V is the molar volume. In addition to the above, the solubility parameter can be calculated via group contribution methods such as those by van Krevelen [D. W. van Krevelen, Fuel 44, 229 (1965)] and van Krevelen and Hoftyzer [D. W. van Krevelen and P. J. Hoftyzer, J. Appl. Polym. Sci. 11, 2189 (1967)]. These methods assume that the (dispersion, polar, or H-bonding) solubility parameter δᵢ can be calculated according to (E. A. Grulke, in Polymer Handbook, 3^{rd} ed., J. Bandrup and E. H. Immergut (Ed.), Wiley, New York, 1989, p.

$${δ}_{i} = {( \frac{{\sum }_{j} {n}_{j} Δ {e}_{j}}{{V}_{i}} )}^{1 / 2}$$

where Δeⱼ is the energy of vaporization contribution associated with the functional group j, nⱼ is the quantity of groups of type j in the molecule, and Vᵢ is the molar volume of species i.

Without wishing to be bound by theory, one condition for solubility is that the difference in δ between solvent and solute be less than 7 (MegaPascals)^{1/2} (MPa)^{1/2}. For example, δ for the polymer Plasdone S630 copolymer is 26.4 (MPa)^{1/2} and that for the alcohol isopropanol is less than 23.5 (MPa)^{1/2}. As such, the difference in δ is 2.9 (MPa)^{1/2}, notably less than 7 (MPa)^{1/2}. Polymers such as polyacrylates, polyvinylpyrrolidone, polyvinyl acetate, polyethylene oxide, for example, can be used when a solvent is used such that the absolute difference between corresponding δ values are less than 7 (MPa)^{1/2}. In some embodiments, the structuring agent thus can be a polymer exhibiting a difference in the solubility parameter compared with the solvent in the range of about 1 (MPa)^{1/2} to about 6.9 (MPa)^{1/2}, about 1.5 (MPa)^{1/2} to about 6.8 (MPa)^{1/2}, or about 2 (MPa)^{1/2} to about 6.5 (MPa)^{1/2}. In further embodiments, the solubility parameter difference can be less than 7 (MPa)^{1/2}, less than 6.8 (MPa)^{1/2}, less than 6.5 (MPa)^{1/2}, less than 6 (MPa)^{1/2}, or less than 5.5 (MPa)^{1/2}.

In certain embodiments, the structuring agent can be present in the final unit dose structure in an amount of about 5% to about 25% by weight, about 10% to about 22% by weight, or about 12% to about 20% by weight, based on the total weight of the unit dose composition. In further embodiments, the unit dose composition can comprise at least 5%, at least 7%, at least 10%, or at least 12% by weight of the structuring agent, based on the total weight of the unit dose composition. In such embodiments, an upper limit (i.e., no greater than) can be applied, such as an upper limit of 40%, 35%, or 30% by weight based on the total weight of the unit dose composition.

In certain embodiments, physical properties of the unit dose composition may rely at least in part on a ratio of the concentration of the structuring agent to the concentration of the anhydrous salt in the unit dose composition. Utilizing the appropriate ratio in particular can provide a balance of hardness and elasticity that allows the unit dose compositions to retain their unit dose structure by resisting crumbling or breaking and also resisting excessive deformation from the original shape. In some embodiments, a ratio (wt./wt.) of a structuring agent to an anhydrous salt in the final unit dose composition can be in the range of about 0.1 to about 0.6, about 0.1 to about 0.5, or about 0.2 to about 0.5.

In one or more embodiments, the unit dose composition can include a detergent. As used herein, a detergent can be any material that is recognized for use in a cleaning composition for providing cleaning efficacy. The cleaning efficacy particularly can be toward clothing or textiles generally. Likewise, the cleaning efficacy can be toward dishware or cookware. Further, the efficacy can be toward industrial uses. Cleaning efficacy can be defined in relation to the ability to at least partially remove soiling agents (e.g., dirt), grease, oils, plant stains, and the like that can be present on an article to be cleaned. Cleaning efficacy likewise can be defined in relation to the ability to whiten and/or brighten an article to be cleaned. In various embodiments, the detergent can be selected from the group consisting of surfactants, builders, alkalinizing agents, enzymes, optical brighteners, antiredeposition polymers, fluorescent whitening agents, bleaches, pearl luster agents, and combinations thereof. In various embodiments, the detergent composition can be any of the following, which are not limiting and are provided only as examples of the types of combinations that can be suitable: one or more non-ionic surfactants; one or more anionic surfactants; a combination of one or more non-ionic surfactants with one or more anionic surfactants; one or more builders; a combination of one or more builders with one or more non-ionic surfactants and/or one or more anionic surfactants; one or more enzymes: a combination of one or more enzymes and one or more non-ionic surfactants and/or one or more anionic surfactants and/or one or more builders; one or more bleaches; a combination of one or more bleaches with one or more non-ionic surfactants and/or one or more anionic surfactants and/or one or more builders; a combination of one or more antiredeposition polymers with one or more non-ionic surfactants and/or one or more anionic surfactants and/or one or more builders.

In various embodiments, a suitable anionic surfactant may include one or more salts (e.g., sodium, potassium, ammonium, and substituted ammonium salts such as mono-, di- and triethanolamine salts) of anionic sulfates, sulfonates, carboxylates, and sarcosinates. Exemplary anionic sulfates can include linear and/or branched primary and secondary alkyl sulfates, alkyl ethoxysulfates, fatty oleoyl glycerol sulfates, alkyl phenol ethylene oxide ether sulfates, C₅-C₁₇ acyl-N—(C₁-C₄ alkyl) and —N—(C₁-C₂ hydroxyalkyl) glucamine sulfates, and sulfates of alkylpolysaccharides, such as alkylpolyglucoside sulfates. Exemplary alkyl sulfates can include linear and branched primary C₁₀-C₁₈ alkyl sulfates. Exemplary alkyl ethoxy sulfate surfactants can include C₁₀-C₁₈ alkyl sulfates that have been ethoxylated with from 0.5 to 20 moles of ethylene oxide per molecule. Exemplary anionic sulfonate surfactants can include salts of C₅-C₂₀ linear alkylbenzene sulfonates, alkyl ester sulfonates, C₆-C₂₂ primary or secondary alkane sulfonates. C₆-C₂₄ olefin sulfonates, sulfonated polycarboxylic acids, alkyl glycerol sulfonates, fatty acyl glycerol sulfonates, fatty oleyl glycerol sulfonates, and any mixtures thereof. Exemplary anionic carboxylates can include alkyl ethoxy carboxylates, and alkyl polyethoxy polycarboxylates. In some embodiments, preferred anionic surfactants can include various sulfates (e.g., alkyl ether sulfates, such as laureth sulfate salts), alkyl ester sulfonates, and alkylbenzene sulfonate (e.g., C₅ to C₂₀ or C₁₀ to C₁₆). Non-limiting examples of anionic surfactants that can be used herein include sodium laureth sulfate (SLES), sodium lauryl sulfate (SLS), methyl ester sulfonate (MES), and sodium C₁₀₋₁₆ alkylbenzene sulfonate (LAS). In certain embodiments, ethoxylated anionic surfactants can be utilized and may comprise a limited number of moles of ethylene oxide groups. For example, an alkyl ether sulfate anionic surfactant may comprise less than 5 moles, or less than 4 moles of ethylene oxide groups, such as 1 to 4 or 2 to 3 ethylene oxide groups. A single anionic surfactant can be utilized or a plurality of anionic surfactants (e.g., 2, 3, 4, or more) can be used.

In various embodiments, a suitable nonionic surfactant may include alkyl ethoxylate condensation products of aliphatic alcohols with from 1 to 25 moles of ethylene oxide wherein the alkyl chain of the aliphatic alcohol can either be straight or branched, primary or secondary, and generally contains from 6 to 22 carbon atoms. Further suitable nonionic surfactants can include water soluble ethoxylated C₆-C₁₈ fatty alcohols and C₆-C₁₈ mixed ethoxylated/propoxylated fatty alcohols. For example, the ethoxylated fatty alcohols can be C₁₀-C₁₈ ethoxylated fatty alcohols with a degree of ethoxylation of from 3 to 20. In some embodiments, mixed ethoxylated/propoxylated fatty alcohols can have an alkyl chain length of from 10 to 18 carbon atoms, a degree of ethoxylation of from 3 to 30, and a degree of propoxylation of from 1 to 10. In further embodiments, suitable nonionic surfactants can include those formed from the condensation of ethylene oxide with a hydrophobic base formed by the condensation of propylene oxide with propylene glycol. Examples of compounds of this type include certain of the commercially-available Pluronic™ surfactants, marketed by BASF. Further, suitable nonionic surfactants can include those formed from the condensation of ethylene oxide with the product resulting from the reaction of propylene oxide and ethylenediamine. Examples of this type of nonionic surfactant include certain of the commercially available Tetronic™ compounds, marketed by BASF. In certain embodiments, suitable nonionic surfactants can be selected, for example, from various alcohol ethoxylates. In some embodiments, the nonionic surfactant can be defined in relation to the alcohol chain length and/or the number of ethoxylate groups present in the molecule. For example, the nonionic surfactant can comprise an alcohol ethoxy late formed from an alcohol with a carbon chain length of 3 to 20 carbon atoms, 5 to 20 carbon atoms, 7 to 19 carbon atoms, 9 to 18 carbon atoms, 10 to 17 carbon atoms, or 12 to 15 carbon atoms. As a further example, the nonionic surfactant can comprise an alcohol ethoxylate having 2 to 10, 4 to 9, or 6 to 8 moles of ethylene oxide per mole of alcohol. Non-limiting examples of nonionic surfactants that can be used herein include ethoxylated alcohols (AE) (C₁₂₋₁₅ alcohols, in particular), such as those available under the tradename NEODOL® (specifically available as NEODOL® 25-7), lauryl or myristyl glucosides (APG), and polyoxyethylene alkylethers (2° AE). A single nonionic surfactant can be utilized or a plurality of nonionic surfactants (e.g., 2, 3, 4, or more) can be used.

Suitable builders useful as a detergent component can be effective as alkalinizing agents. For example, various alkali carbonates and/or other inorganic alkalinizing agents can be utilized. Preferably, sodium and/or potassium salts (e.g., K₂CO₃ and/or Na₂CO₃) can be used. For example, soda ash can be used. In some embodiments, one or more components can be utilized for formation of a carbonate in situ. For example, bicarbonates and hydroxides in combination can be effective for in situ formation of a carbonate. In an example embodiment, sodium bicarbonate and sodium hydroxide can be utilized for this purpose, and other forms of bicarbonates and hydroxides may likewise be utilized.

The detergent composition can be a peroxide precursor composition. For example, sodium percarbonate, which is an adduct of hydrogen peroxide complexed with sodium carbonate, can be used. Such materials can be characterized as “bleaches” in relation to their stain removing ability or as whiteners or brighteners.

In one or more embodiments of the present disclosure, the unit dose compositions can include a plasticizer. The plasticizer can be any material that is effective for improving binding between the structuring agent and the alcoholate complex components. For example, the plasticizer can be a material that at least partially solvates polymers useful as the structuring agent to increase binding of the polymer with the salt/alcohol matrix. As such, the plasticizer can be characterized as being an organic solvent. Solubility of the structuring agent in the plasticizer can be assessed using the solubility parameter theory as already described above. In some embodiments, the difference in δ between solvent (plasticizer) and solute (structuring agent) can be less than 7 (MPa)^{1/2}. The plasticizer can thus exhibit a difference in δ with respect to the structuring agent in the range of about 1 (MPa)^{1/2} to about 6.9 (MPa)^{1/2}, about 1.5 (MPa)^{1/2} to about 6.8 (MPa)^{1/2}, or about 2 (MPa)^{1/2} to about 6.5 (MPa)^{1/2}. In further embodiments, the solubility parameter difference can be less than 7 (MPa)^{1/2}, less than 6.8 (MPa)^{1/2}, less than 6.5 (MPa)^{1/2}, less than 6 (MPa)^{1/2}, or less than 5.5 (MPa)^{1/2}. In further embodiments, the plasticizer can be any material having a relatively low volatility, which can be determined based on the vapor pressure, which can be measured using known experimental methods or calculated using known equations. For example, the plasticizer can have a vapor pressure that is less than 12 mm Hg (about 1600 Pa), less than 10 mm Hg (about 1333 Pa), less than 8 mm Hg (about 1067 Pa) less than 5 mm Hg (about 667 Pa), or less than 3 mm Hg (about 400 Pa) when measured at 20° C. In some embodiments, the vapor pressure can be about 0.0001 mm Hg (about 0.0133 Pa) to about 10 mm Hg (about 1333 Pa), about 0.0001 mm Hg (about 0.0133 Pa) to about 6 mm Hg (800 Pa), or about 0.0001 mm Hg (about 0.0133 Pa) to about 4 mm Hg (about 533 Pa) when measured at 20° C.

In example embodiments, the plasticizer may be a glycol ether, such as diethylene glycol hexyl ether (also called hexyl carbitol). For example, diethylene glycol hexyl ether exhibits a vapor pressure of 0.001 mm Hg at 20° C. and results in a δ difference values of 6.6 (MPa)^{1/2} compared with S630 Plasdone polymer, which is only one example of a polymer useful as a structuring agent according to the present disclosure. The activity of the plasticizer can be effective to increase deformation of the unit dose solid by softening of the structuring agent; however, excess plasticizer can undesirably lower hardness, and it is beneficial to create a balance of hardness and deformability in the unit dose composition that results in toughness whereby the unit dose composition resists breaking through deformation but resists excessive deformation in light of the hardness.

In some embodiments, the unit dose compositions according to the present disclosure can comprise the plasticizer in an amount of about 0.1% to about 5% by weight, about 0.5% to about 4.5% by weight, or about 1% to about 4% by weight, based on the total weight of the unit dose composition. In further embodiments, the unit dose composition can comprise at least 0.1%, at least 0.2%, at least 0.5%, or at least 1.0% by weight of the plasticizer, based on the total weight of the unit dose composition. In such embodiments, an upper limit (i.e., no greater than) can be applied, such as an upper limit of 10%, 8%, or 5% by weight based on the total weight of the unit dose composition.

In the present disclosure, the unit dose composition is configured as a unified solid. In the embodiments, a unified solid is differentiated from a powder or other solid format that exists as a plurality of smaller particles that do not remain bonded together as a larger unit dose format. In some embodiments, however, the unit dose composition can be characterized as a pellet, disk, puck, tablet, or the like that is understood to be a single, unified solid object of sufficient dimensions to provide the detergent component in a useful amount. For example, a unit dose composition of the present disclosure can have a length, width, and thickness that independently are within the range of about 1 cm to about 10 cm, about 1.5 cm to about 8 cm, or about 2 cm to about 6 cm. Similarly for a substantially spherical or elliptical shape, the single unit dose composition can have an average diameter of about 2 cm to about 10 cm, about 2.5 cm to about 8 cm, or about 3 cm to about 6 cm.

The unified solid form of the unit dose composition can denote a solid structure that does not separate without significant force applied to the structure above an acceptable amount. The unified solid can be a rigid structure but also have a sufficient degree of deformation to resist breaking under applied force. In some embodiments, the unified solid has a hardness value defined by exhibiting a peak force at breakage of at least 100 Newtons, at least 120 Newtons. at least 150 Newtons, at least 170 Newtons, or at least 190 Newtons. The unified solid likewise can have a percent deformation at peak force of about 5% to about 50%. about 10% to about 40%, or about 20% to about 30%. Hardness and deformation can be evaluated by any acceptable method. For example, such valued can be obtained by standard operation of a texture analyzer, such as available from Brookfield Ametek. In an example embodiment, a blade attached to the texture analyzer can be lowered towards a test material (e.g., a unified solid composition according to the present disclosure) at a defined rate, such as about 0.50 mm/s. Peak force can be identified as the point at which breakage of the unified solid occurs. Percent deformation can be identified based on how far the blade penetrates the unified solid before breakage occurs.

As already noted above, traditional unit dose compositions require a film or envelope to enclose and retain the material in the unit dose form. In the present disclosure, the unit dose composition is configured as a unified solid without the need of a film or envelope to conform to the structure of the composition. Even in the absence of such additional surrounding material, the unit dose composition in its form as a unified solid effectively retains its shape and mass as originally formed until the time of use by a consumer. At use. the unit dose composition preferably is water soluble. In some embodiments, the unified solid is configured to achieve at least 95% dissolution in deionized water in a time of about 30 seconds to about 8 minutes, about 1 minute to about 7 minutes, or about 2 minutes to about 6 minutes. Dissolution is evaluated as the time to achieving about 95% by weight of the unit dose being solubilized in the deionized water. Dissolution can be tested, for example, by placing the unified solid in one liter of deionized water having a temperature of about 22° C. and stirring at 300 revolutions per minute (rpm) until the article has become solubilized in the water, as evaluated using visual inspection. As described herein, the dissolution time can vary depending on the temperature of the water. Dissolution is important for releasing the active ingredients in the unified solid, such releasing a laundry detergent material in a washing machine so that cleaning can occur. Shorter dissolution times lead to better the cleaning performance as the active ingredients have more exposure time to the garments to effectively clean. Preferably, the composition exhibits a dissolution time of less than 12 minutes, less than 10 minutes, less than 8 minutes, or less than 6 minutes when tested under the above-noted conditions. For example, exhibited dissolution time can be about 0.5 minutes to about 10 minutes, about 1 minute to about 9 minutes, or about 2 minutes to about 8 minutes. As further described in Example 1 and Example 8, the unified solid dissolution time is comparably measurable to the dissolution time of a commercial laundry unit dose with liquid placed in a polyvinyl alcohol pouch.

The unit dose compositions preferably comprise little to no water. Since the formation of the matrix depends on reaction between the alcohol and the anhydrous salt, it is beneficial to limit water content and thus competition for reacting with the anhydrous salt. In some embodiments, the unit dose composition may comprise less than 5% by weight, less than 4% by weight, less than 3% by weight, less than 2% by weight, less than 1% by weight, or less than 0.5% by weight water, based on the total weight of the final unit dose composition. Although, water preferably is not intentionally added to the unit dose composition, water can be present in a small amount due to inclusion with other raw materials (such as surfactant), or due to some degradation reactions that produce water, such as the degradation of sodium percarbonate. The unit dose compositions thus may be described as excluding added water, which can be defined as free water that is added to the composition as a stand-alone material as opposed to being a component of the chemistry of another material used in the composition.

In one or more embodiments, the present disclosure can further provide a method of making a unit dose composition. The method generally can comprise preparing a pre-mixture of less than all of the components of the composition and then adding at least one further component of the composition that is effective to begin a reaction to form a complex. For example, a method according to the present disclosure can comprise combining a structuring agent, a detergent, and an alcohol to form a mixture. The method can further comprise combining an anhydrous salt with the mixture to form an intermediate composition. The method can also comprise curing the intermediate composition in unit dose amounts under conditions such that the anhydrous salt reacts with the alcohol to form a complex. The complex can structurally include the structuring agent and the detergent to provide the unit dose amounts as individual units of a unified solid. In some embodiments, combining further includes combining a plasticizer to form the mixture.

### Example 1

A test composition was prepared by first preparing a Part A mixture that included an alcohol, a polymer, a plasticizer, and a surfactant effective as a laundry detergent. The formulation for Part A mixture is shown in Table 1 below.

TABLE 1
Example of Part A mixture

| Component | Wt. % |
|---|---|
| 2-propanol | 61.50 |
| Plasdone ™ S-630 | 27.30 |
| [poly(vinylpyrrolidone-co-vinyl | |
| acetate), PVAc-PVP] | |
| Diethylene glycol hexyl | 3.00 |
| ether (Hexyl Carbitol) | |
| Sodium dodecyl sulfate | 8.2 |

The Part A mixture in an amount of 60.98 weight percent (Wt. %) was then combined with 39.02 Wt. % of the anhydrous salt, calcium chloride. The combined materials formed a soft dough-like intermediate material and was pressed into silicone molds. The silicone molds formed unit dose “blocks” of 40 mm×40 mm×20 mm dimension having a mass weight about 20 grams (g). Within 5 minutes of setting the intermediate mixture in the molds, a unified solid was formed. The overall formulation is shown in Table 2 below.

TABLE 2
Example unit dose composition.

| Component | Wt. % |
|---|---|
| 2-propanol | 37.50 |
| Plasdone ™ S-630 | 16.65 |
| [poly(vinylpyrrolidone-co-vinyl | |
| acetate), PVAc-PVP] | |
| Diethylene glycol hexyl | 1.83 |
| ether (Hexyl Carbitol) | |
| Sodium dodecyl sulfate | 5.00 |
| CaCl₂ (anhydrous) | 39.02 |

After formation of the unit dose composition, the unified solids were then tested for dissolution. To be effective, the unit dose composition should display comparable dissolvability properties to traditional unit dose compositions contained with an envelope, or film, or other forms. One liter of deionized water having a temperature of 22 degrees Celsius (° C.) was placed in a 1500 milliliter (ml) beaker and stirred at 300 revolutions per minute (rpm) with a magnetic stir bar (⅜″×2½″). Full dissolution was observed at about 6 minutes after adding the unified solid to the water. As described herein, the dissolution time can vary depending on the temperature of the water. A typical wash cycle is on the order of about 10 to about 12 minutes long. As such, a target dissolution time of the unified solids should be less than 12 minutes and leave enough time of exposure of the active ingredients to the garments that cleaning can occur. Preferably, the dissolution time is less than about 8 minutes, such that the shorter the time, the better the cleaning performance. To compare the dissolution of the unit dose composition described herein to a dissolution of a commercial laundry unit dose, with liquid placed in a polyvinyl alcohol pouch, the commercial laundry unit dose was measured at about 6.5 minutes into a wash cycle, at which time the polymer was fully dissolved in the wash water. However, breakage of the pouch, with release of the active ingredients, was noted to be about 2.5 minutes.

### Example 2

Eight separate unit dose compositions were prepared to test the formation of the matrix formed between different anhydrous salts and alcohol. For the testing, 2-proponal was used as the alcohol. The anhydrous salts tested included Magnesium Chloride (MgCl₂), Calcium Chloride (CaCl₂)), Strontium Chloride (SrCl₂), and Barium Chloride (BaCl₂). The unit dose compositions prepared using the Part A mixture from Example 1 along with the anhydrous salts are shown below in Table 3 (values in weight %).

TABLE 3
Unit dose compositions with MgCl₂, CaCl₂, SrCl₂, and BaCl₂.

| Component | 97-1a | 97-1b | 97-1c | 97-1d | 97-2a | 97-2b | 97-2c | 97-2d |
|---|---|---|---|---|---|---|---|---|
| Part A1 | 60.98 | 60.98 | 60.98 | 60.98 | 64.55 | 60.98 | 35.56 | 29.32 |
| from | | | | | | | | |
| Example 1 | | | | | | | | |
| MgCl₂ | 39.02 | | | | 35.45 | | | |
| CaCl₂ | | 39.02 | | | | 39.02 | | |
| SrCl₂ | | | 39.02 | | | | 64.44 | |
| BaCl₂ | | | | 39.02 | | | | 70.68 |

Each component in the unit dose compositions containing the alcohol, structuring agent, plasticizer, detergent, and anhydrous salt are shown below in Table 4 (values in Wt. %).

TABLE 4
Overall unit dose compositions with MgCl₂, CaCl₂, SrCl₂, and BaCl₂.

| Component | 97-1a | 97-1b | 97-1c | 97-1d | 97-2a | 97-2b | 97-2c | 97-2d |
|---|---|---|---|---|---|---|---|---|
| 2-propanol | 37.50 | 37.50 | 37.50 | 37.50 | 39.70 | 37.50 | 13.34 | 18.03 |
| Plasdone ™ S-630 | 16.65 | 16.65 | 16.65 | 16.65 | 17.62 | 16.65 | 9.71 | 8.00 |
| [poly(vinylpyrrolidone- | | | | | | | | |
| co-vinyl acetate), | | | | | | | | |
| PVAc-PVP] | | | | | | | | |
| Diethylene glycol hexyl | 1.83 | 1.83 | 1.83 | 1.83 | 1.94 | 1.83 | 1.07 | 0.88 |
| ether (Hexyl Carbitol) | | | | | | | | |
| Sodium dodecyl sulfate | 5.00 | 5.00 | 5.00 | 5.00 | 5.29 | 5.00 | 2.92 | 2.40 |
| MgCl₂ | 39.02 | | | | 35.45 | | | |
| CaCl₂ | | 39.02 | | | | 39.02 | | |
| SrCl₂ | | | 39.02 | | | | 64.44 | |
| BaCl₂ | | | | 39.02 | | | | 70.68 |

Compositions 97-lc, 97-ld, 97-2c, and 97-2d did not result in rigid structures but rather set up as soft pastes or dispersions that separated. From the testing sample, those formed using MgCl₂ and CaCl₂) formed the desired unified solid unit dose compositions. Without wishing to be bound by theory, it is believed that the results arose from the differing electronegativities of the cationic components of the tested anhydrous salts.

Dissolution testing was next conducted. One liter of deionized water having a temperature of 22° C. was placed in a 1500 ml beaker and stirred at 300 rpm with a magnetic stir bar (⅜″×2½″). Full dissolution time in minutes after adding the test compositions that formed unified solid structures to the water are shown below in Table 5.

TABLE 5
Dissolution time in minutes of sample unit
dose compositions forming unified solids.

| Sample | Dissolution time (min) |
|---|---|
| 97-1a | 3.5 |
| 97-1b | 4.5 |
| 97-2a | 2.5 |
| 97-2b | 4.5 |

### Example 3

Part A3 mixture was prepared using an alcohol, structuring agent, plasticizer, and a surfactant (values in Wt. %). The example formulation is shown below in Table 6

TABLE 6
Part A3 mixture containing a surfactant, Surfonic L24-9 (NRE).

| Component | Weight % |
|---|---|
| 2-propanol | 61.50 |
| Plasdone ™ S-630 | 27.30 |
| [poly(vinylpyrrolidone-co-vinyl | |
| acetate), PVAc-PVP] | |
| Diethylene glycol hexyl | 3.00 |
| ether (Hexyl Carbitol) | |
| Surfonic ® L24-9 (NRE) | 8.2 |

Part A3 was then mixed with either MgCl₂ or CaCl₂ to form a unit dose composition with a unified solid structure. As shown below in Table 7, samples 98-1c and 98-1d also contained a detergent (sodium dodecyl sulfate) (values in Wt. %).

TABLE 7
Content of anhydrous salts for samples 98-1a, 98-1b, 98-1c, 98-1d.

| Component | 98-1a | 98-1b | 98-1c | 98-1d |
|---|---|---|---|---|
| Part A3 | 64.55 | 60.98 | 61.38 | 58.14 |
| MgCl₂ | 35.45 | | 33.71 | |
| CaCl₂ | | 39.02 | | 37.21 |
| Sodium dodecyl sulfate | | | 4.91 | 4.65 |

The overall weight % of the components of the unit dose compositions for samples 98-1a. 98-1b, 98-1c. 98-1d are shown below in Table 8.

TABLE 8
Overall unit dose composition wt. % for
samples 98-1a, 98-1b, 98-1c, 98-1d.

| Component | 98-1a | 98-1b | 98-1c | 98-1d |
|---|---|---|---|---|
| 2-propanol | 39.70 | 37.50 | 37.75 | 35.76 |
| Plasdone ™ S-630 | 17.62 | 16.65 | 16.76 | 15.87 |
| [poly(vinylpyrrolidone-co-vinyl | | | | |
| acetate), PVAc-PVP] | | | | |
| Diethylene glycol hexyl | 1.94 | 1.83 | 1.84 | 1.74 |
| ether (Hexyl Carbitol) | | | | |
| Surfonic L24-9 (NRE) | 5.29 | 5.00 | 5.03 | 4.77 |
| MgCl₂ | 35.45 | | 33.71 | |
| CaCl₂ | | 39.02 | | 37.21 |
| Sodium dodecyl sulfate | | | 4.91 | 4.65 |

Following the formation of the samples, dissolution testing was completed. One liter of deionized water having a temperature of 22° C. was placed in a 1500 ml beaker and stirred at 300 rpm with a magnetic stir bar (⅜″×2½″). Full dissolution time in minutes after adding samples 98-1a, 98-1b. 98-1c, and 98-1d to the water are shown below in Table 9.

TABLE 9
Dissolution times for samples 98-1a, 98-1b, 98-1c, and 98-1d.

| Sample | Dissolution time (min) |
|---|---|
| 98-1a | 2.5 |
| 98-1b | 3.0 |
| 98-1c | 2.5 |
| 98-1d | 4.5 |

### Example 4

Testing was carried out to evaluate the effect of varying ratios of the structuring agent and the anhydrous salt components on physical properties for the formed unit dose compositions. Seven test samples were evaluated as shown in Table 10 below (values in Wt. %).

TABLE 10
Compositions varying ratio of structuring agent to anhydrous salt.

| Component | 5632-4-2 | 5632-4-3 | 5632-5-2 | 5632-5-1 | 5632-4-1 | 5632-5-3 | 5632-5-4 |
|---|---|---|---|---|---|---|---|
| 2-proponal | 57.32 | 39.7 | 39.7 | 39.7 | 39.7 | 39.7 | 39.7 |
| Plasdone ™ S-630 | | | 5.81 | 11.81 | 17.62 | 22.85 | 26.535 |
| Hexyl carbitol | 1.94 | 2.74 | 1.94 | 1.94 | 1.94 | 1.94 | 1.94 |
| sodium dodecyl | 5.29 | 7.47 | 5.29 | 5.29 | 5.29 | 5.29 | 5.29 |
| sulfate (SDS) | | | | | | | |
| MgCl₂ | 35.45 | 50.09 | 47.26 | 41.26 | 35.45 | 30.22 | 26.535 |
| Ratio S-630/MgCl₂ | 0 | 0 | 0.12 | 0.29 | 0.5 | 0.76 | 1.0 |

The solid unit pucks were prepared as described in Example 1. Pucks were trimmed to an approximate size of 4 cm (length)×4 cm (length)×2 cm (height). Hardness values of each puck were evaluated using a Brookfield Texture Analyzer. A unit dose puck was placed on a platform located beneath a plastic blade (Brookfield geometry TA7) of dimensions 6 cm (width)×5 cm (height)×0.3 cm (width), with the edge tapered to fine point. The blade was lowered towards the puck at 0.50 mm/s while force was recorded as a function of time and position. Parameters of peak force and percent deformation, defined as the percent penetration depth relative to the height of the puck at the peak force, were recorded. Peak force was identified as the point at which breakage of the puck occurred. Percent deformation was identified based on how far the blade penetrated the puck before breakage occurred.

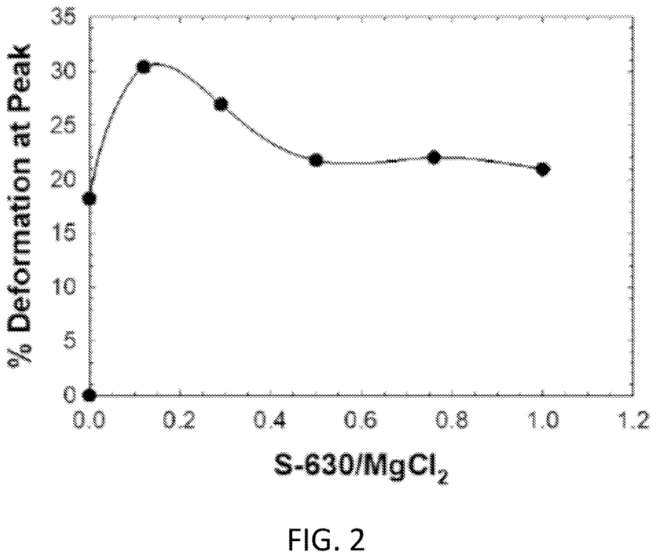

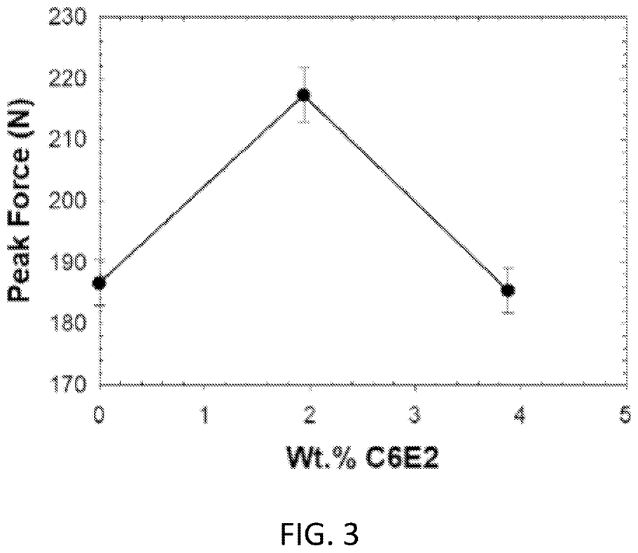

Peak force values and percent deformation values are shown in Table 11 below. In FIG. 2, Peak force (hardness) values are plotted against the ratio of structuring agent concentration to anhydrous salt concentration In FIG. 3, percent deformation values are plotted against the ratio of structuring agent concentration to anhydrous salt concentration.

TABLE 11
Hardness and deformation test values for different ratios of structuring
agent concentration to anhydrous salt concentration.

| | Ratio of structuring agent | | |
|---|---|---|---|
| Sample | concentration to anhydrous | Peak | % Deformation |
| 5632- | salt concentration | Force (N) | at Peak Force |
| 4-2 | 0 | 0 | 0 |
| 4-3 | 0 | 31.44 | 18.20 |
| 5-2 | 0.12 | 145.65 | 30.40 |
| 5-1 | 0.29 | 238.16 | 26.95 |
| 4-1 | 0.50 | 217.28 | 21.75 |
| 5-3 | 0.76 | 126.70 | 22.00 |
| 5-4 | 1.00 | 128.60 | 20.95 |

Testing results show that composition 5632-4-2, which included no polymer, had no structural integrity and failed to form a defined shape. The force for composition 5632-4-2 was therefore recorded as 0. Composition 5632-4-3 held shape but exhibited a relatively small peak force and deformation before breaking. Points for both composition 4-2 and composition 4-3 are shown in FIG. 2 and FIG. 3.

As shown in Table 11, inclusion of the structuring agent was effective to not only bind the components together into a defined shape but provide structural integrity to the composition. A peak in the hardness value was seen around a structuring agent to anhydrous salt ratio of 0.29. The peak in the % deformation was seen at a slightly lower ratio of 0.12. although this value was similar to the values at a ratio of 0.29. This indicated that the ratio of the two components can be adjusted for optimal for hardness and deformation. Optimal hardness and deformability are relevant properties for product integrity, for example, when a product may experience rough handling during shipping.

### Example 5

Testing was carried out to identify effects of varying the amount of plasticizer present in the unit dose composition. As shown below in Table 12, compositions were prepared containing different levels of Hexyl Carbitol (C6E2, diethyleneglycol hexyl ether) (values in Wt. %).

TABLE 12
Compositions with varying levels of hexyl carbitol.

| Component | 5632-4-4 | 5632-4-1 | 5632-4-5 |
|---|---|---|---|
| 2-proponal | 41.64 | 39.7 | 37.76 |
| Plasdone ™ S-630 | 17.62 | 17.62 | 17.62 |
| Hexyl Carbitol | | 1.94 | 3.88 |
| sodium dodecyl | 5.29 | 5.29 | 5.29 |
| sulfate (SDS) | | | |
| MgCl₂ | 35.45 | 35.45 | 35.45 |
| Ratio S-630/MgCl₂ | 0.5 | 0.5 | 0.5 |

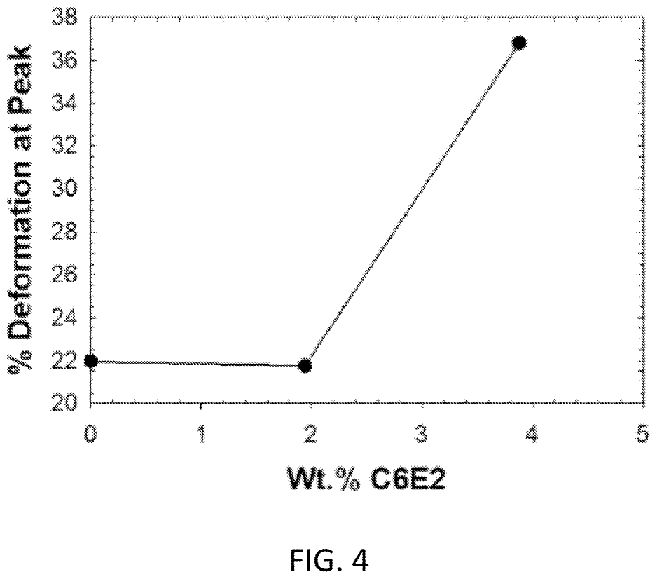

The compositions were tested with the texture analyzer as described above. Data for peak force (hardness) and percent deformation are shown in FIG. 4 and FIG. 5, respectively. Data is also presented in Table 13. FIG. 4 is a graphical representation of Peak force (hardness) values plotted against plasticizer weight %.

FIG. 5 is a graphical representation of percent deformation at peak force (hardness) values plotted against plasticizer weight %.

TABLE 13
Hardness test values for levels of hexyl carbitol.

| Sample | Weight % | Peak | % Deformation |
|---|---|---|---|
| 5632- | C6E2 | Force (N) | at Peak Force |
| 4-4 | 0 | 186.70 | 21.95 |
| 4-1 | 1.94 | 217.28 | 21.75 |
| 4-5 | 3.88 | 185.48 | 36.80 |

The testing indicated that the plasticizer can be beneficial to improve hardness, possibly by plasticizing the structuring agent polymer enough to interact and adhere to the other components of the solid matrix. Excessive inclusion of the plasticizer, however, can decrease the peak hardness force, although with further increased deformation. The plasticizer content thus can be beneficial to customize deformation properties as needed.

### Example 6

Additional testing was carried out to evaluate cleaning efficacy of the unit dose compositions. Table 14 describes compositions that were prepared with various levels of sodium percarbonate (NaPC) included as a detergent component.

TABLE 14
Compositions with NaPC. All values are in weight %.

| Component | 5573-113-1 | 5573-113-2 | 5573-113-3 |
|---|---|---|---|
| 2-propanol | 37.75 | 31.07 | 23.39 |
| Plasdone ™ S-630 | 16.76 | 13.79 | 10.38 |
| Diethylene glycol hexyl | 1.84 | 1.52 | 1.14 |
| ether (Hexyl Carbitol) | | | |
| Surfonic L24-9 (NRE) | 5.03 | 4.14 | 3.12 |
| MgCl₂ | 33.71 | 27.75 | 20.89 |
| NaPC | 0.00 | 17.68 | 38.03 |
| SDS | 4.91 | 4.04 | 3.04 |

The compositions in Table 14 were evaluated for wash performance by adding two pucks (size approximately 4 cm×4 cm×2 cm) to a full wash (about 70 L) with test flags containing the stains and soils, as shown in Table 15. In Table 15, “C” refers to stains presented on a cotton flag and “PC” refers to stains 5 presented on a polyester cotton blend flag.

TABLE 15
Stains and soils used in wash study.

| | |
|---|---|
| C-Ball Point Ink | PC-Ball Point Ink |
| C-Beef Tallow and Pork Lard | PC-Beef Tallow and Pork Lard |
| with Carbon Black | with Carbon Black |
| C-Blood | PC-Blood |
| C-Blueberry | PC-Blueberry |
| C-Burnt Butter with | PC-Burnt Butter with |
| Carbon Black | Carbon Black |
| C-Chocolate Syrup | PC-Chocolate Syrup |
| C-Chocolate Ice Cream | PC-Chocolate Ice Cream |
| C-Clay | PC-Clay |
| C-Coffee with Milk | PC-Coffee with Milk |
| C-Coffee | PC-Coffee |
| C-Dust Sebum | PC-Dust Sebum |
| C-Grape Juice | PC-Grape Juice |
| C-Grass | PC-Grass |
| C-Gravy | PC-Gravy |
| C-Makeup | PC-Makeup |
| C-Meat Drippings with | PC-Meat Drippings with |
| Carbon Black | Carbon Black |
| C-Motor Oil | PC-Motor Oil |
| C-Mustard | PC-Mustard |
| C-Olive Oil with | PC-Olive Oil with |
| Carbon Black | Carbon Black |
| C-Red Wine | PC-Red Wine |
| C-Spaghetti | PC-Spaghetti |
| C-Tea | PC-Tea |

Washes were performed at 86 degrees Fahrenheit (° F.) using wash water having 120 parts per million (ppm) (as CaCO₃) hardness. Cleaning efficacy was evaluated by comparing color assessments on stains before washing and after washing. Color assessments in the CIE L*a*b* color space (HunterLab, Application Note Vol. 8, No. 7, July 1996) were performed on unwashed and washed stains via image analysis. Values of ΔE, a root mean square color difference between the swatch and a non-soiled standard swatch, were then calculated for unwashed swatches, according to Formula 1 shown below, and washed swatches according to Formula 2 shown below.

$$Before washing : Δ {E}_{u} = {[ {( {L}_{u} - {L}_{o} )}^{2} + {( {a}_{u} - {a}_{o} )}^{2} + {( {b}_{u} - {b}_{o} )}^{2} ]}^{1 / 2} \qquad Formula 1$$

$$After washing : Δ {E}_{w} = {[ {( {L}_{w} - {L}_{o} )}^{2} + {( {a}_{w} - {a}_{o} )}^{2} + {( {b}_{w} - {b}_{o} )}^{2} ]}^{1 / 2} \qquad Formula 2$$

where u, w, and o correspond to values for unwashed swatches, washed swatches, and non-stained swatches, respectively. The % stain removal (% SR) was then calculated according to Formula 3 shown below.

$$\% SR = [ ( Δ {E}_{u} - Δ {E}_{w} ) / Δ {E}_{u} ] \times 100 \qquad Formula 3$$

Composite wash performance scores were calculated by summing % SR scores from each stain.

Composite scores from a commercial laundry detergent. a commercial laundry sheet product, and the three experimental products are compared below in Table 16.

TABLE 16
Composite % SR values from wash study.

| Wash detergent | Composite % SR |
|---|---|
| Arm & Hammer Clean Burst Liquid | 1623 |
| Breezeo Sheet | 1473 |
| 5573-113-1 | 1671 |
| 5573-113-2 | 1690 |
| 5573-113-3 | 1701 |

Wash results showed that the inventive samples performed well compared to current wash systems. Increasing levels of sodium percarbonate improved wash performance.

### Example 7

The following two compositions were prepared to measure the dissolution time between the compositions. In the formulations, the ratio of alcohol to salt were varied. The remaining components remained constant.

TABLE 17
Compositions with varying alcohol/salt ratios.

| | 5632-15-1 | 5632-16-1 |
|---|---|---|
| Component | (wt. %) | (wt. %) |
| 2-propanol | 38.19 | 34.03 |
| Plasdone 630 | 13.79 | 13.79 |
| Diethylene glycol hexyl | 1.52 | 1.52 |
| ether (Hexyl Carbitol) | | |
| Surfonic L24-9 (NRE) | 4.14 | 4.14 |
| Fragrance | 1.00 | 1.00 |
| MgCl2 | 19.43 | 23.59 |
| NaPC | 17.68 | 17.68 |
| SDS | 4.04 | 4.04 |
| Liquitint Blue | 0.20 | 0.20 |
| Ratio Alcohol/Salt | 2.0/1 | 1.4/1 |

The dissolution time for composition 15-1 having a higher alcohol/salt ratio was measured as 1.25 minutes while that of composition 16-1 having a lower alcohol/salt ratio was measured as 2.5 minutes. As shown, increasing the alcohol to salt ratio was found to result in a decreased dissolution time for the solid unit dose composition.

### Example 8

Dissolution time for two compositions made using vinyl acetate/vinyl pyrrolidone (Vac/VP) copolymers of different chemical composition were compared. The Plasdone S630 copolymer had a molecular weight of 43,000 g/mole and a VAc/VP ratio of 1.5. An additional VAc/VP polymer that was sourced from Aldrich Chemical, had a MW of 50,000 g/mole and a VAc/VP ratio of 1.3. The two compositions are shown below in Table 18.

TABLE 18
Ingredients for two compositions with
different structuring agent polymers.

| | Wt. % | Wt. % |
|---|---|---|
| Component | 5632-15-1 | 5632-12-2 |
| 2-propanol | 38.19 | 38.19 |
| Plasdone 630 | 13.79 | |
| Aldrich VAc/VP polymer | | 13.79 |
| Diethylene glycol hexyl | 1.52 | 1.52 |
| ether (Hexyl Carbitol) | | |
| Surfonic L24-9 (NRE) | 4.14 | 4.14 |
| Fragrance | 1.00 | 1.00 |
| MgCl2 | 19.43 | 19.43 |
| NaPC | 17.68 | 17.68 |
| SDS | 4.04 | 4.04 |
| Liquitint Blue | 0.20 | 0.20 |

The dissolution time for composition 15-1 having Plasdone 630 polymer was measured at 1.25 minutes, while the dissolution time for composition 12-2 having Aldrich Vac/VP polymer was measured at 2.5 minutes.

The terms “about” or “substantially” as used herein can indicate that certain recited values or conditions are intended to be read as encompassing the expressly recited value or condition and also values that are relatively close thereto or conditions that are recognized as being relatively close thereto. For example, unless otherwise indicated herein, a value of “about” a certain number or “substantially” a certain value can indicate the specific number or value as well as numbers or values that vary therefrom (+ or −) by 5% or less, 4% or less, 3% or less, 2% or less, or 1% or less, and any one of such values may be used interchangeably with the words “about” and/or “substantially” as needed for clarity. Similarly, unless otherwise indicated herein, a condition that substantially exists can indicate the condition is met exactly as described or claimed or is within typical manufacturing tolerances or would appear to meet the required condition upon casual observation even if not perfectly meeting the required condition. In some embodiments, the values or conditions can be defined as being express and, as such, the term “about” or “substantially” (and thus the noted variances) can be excluded from the express value.

Many modifications and other embodiments of the disclosure set forth herein will come to mind to one skilled in the art to which these disclosures pertain having the benefit of the teachings presented in the foregoing descriptions. Therefore, it is to be understood that the disclosure is not to be limited to the specific embodiments disclosed and that modifications and other embodiments are intended to be included within the scope of the appended claims. Although specific terms are employed herein, they are used in a generic and descriptive sense only and not for purposes of limitation.

1. A unit dose composition comprising:
a complex of an alcohol and an anhydrous salt;
a structuring agent; and
a detergent;
wherein the unit dose composition is configured as a unified solid.

2. The unit dose composition of claim 1, wherein the alcohol is present in an amount of about 30% to about 45% based on the total weight of the unit dose composition.

3. The unit dose composition of claim 1, wherein the anhydrous salt is an anhydrous chloride salt.

4. The unit dose composition of claim 3, wherein the anhydrous salt includes a cation with an electronegativity of at least 1.0.

5. The unit dose composition of claim 1, wherein the anhydrous salt is present in an amount of about 30% to about 45% by weight based on the total weight of the unit dose composition.

6. The unit dose composition of claim 1, wherein the structuring agent comprises a polymer.

7. The unit dose composition of claim 6, wherein the structuring agent comprises an acetate polymer.

8. The unit dose composition of claim 6, wherein the structuring agent comprises a copolymer of an acetate monomer with one or more further monomers.

9. The unit dose composition of claim 1, wherein the structuring agent is present in an amount of about 5% to about 20% by weight based on the total weight of the unit dose composition.

10. The unit dose composition of claim 1, further comprising a plasticizer.

11. The unit dose composition of claim 10, wherein the plasticizer is a liquid that is effective to partially solubilize the structuring agent and increase binding of the structuring agent with the complex of the alcohol and the anhydrous salt.

12. The unit dose composition of claim 10, wherein the plasticizer comprises a glycol hexyl ether.

13. The unit dose composition of claim 10, wherein the plasticizer is present in an amount of about 0.1% to about 5% by weight based on the total weight of the unit dose composition.

14. The unit dose composition of claim 1, wherein the detergent is selected from the group consisting of surfactants, builders, alkalinizing agents, enzymes, optical brighteners, antiredeposition polymers, fluorescent whitening agents, bleaches, pearl luster agents, and combinations thereof.

15. The unit dose composition of claim 1, wherein the unified solid has a hardness value defined by exhibiting a peak force at breakage of at least 190 Newtons and a percent deformation at peak 10 force of about 20% to about 30% when measured with a Texture Analyzer.

16. The unit dose composition of claim 1, wherein the unified solid is neither partially nor fully enclosed in a film or envelope.

17. The unit dose composition of claim 1, wherein the unified solid is water soluble.

18. The unit dose composition of claim 17, wherein the unified solid is configured to achieve at least 95% dissolution in deionized water in a time of about 30 seconds to about 8 minutes.

19. A method of making a unit dose composition, the method comprising:
combining a structuring agent, a detergent, and an alcohol to form a mixture;
combining an anhydrous salt with the mixture to form an intermediate composition; and
curing the intermediate composition in unit dose amounts under conditions such that the anhydrous salt reacts with the alcohol to form a complex that structurally includes the structuring agent and the detergent to provide the unit dose amounts as individual units of a unified solid.

20. The method of claim 19, wherein the combining further includes combining a plasticizer to form the mixture.
